(19) United States
(12) Patent Application Publication
(10) Pub. No.: US 2022/0366247 A1
(43) Pub. Date: Nov. 17, 2022

(54) TRAINING ACTION SELECTION NEURAL NETWORKS USING Q-LEARNING COMBINED WITH LOOK AHEAD SEARCH

(71) Applicant: DeepMind Technologies Limited, London (GB)

(72) Inventors: Jessica Blake Chandler Hamrick, London (GB); Victor Constant Bapst, London (GB); Alvaro Sanchez, London (GB); Tobias Pfaff, London (GB); Theophane Guillaume Weber, London (GB); Lars Buesing, Letchworth Garden City (GB); Peter William Battaglia, London (GB)

(21) Appl. No.: 17/763,920

(22) PCT Filed: Sep. 23, 2020
(86) PCT No.: PCT/EP2020/076597

§ 371 Date: Mar. 25, 2022

Related U.S. Application Data
(60) Provisional application No. 62/905,946, filed on Sep. 25, 2019.

(51) Int. Cl. G06N 3/08; G06N 3/04

(52) U.S. Cl. CPC G06N 3/08; G06N 3/04

(57) ABSTRACT

A reinforcement learning system and method that selects actions to be performed by an agent interacting with an environment. The system uses a combination of reinforcement learning and a look ahead search: Reinforcement learning Q-values are used to guide the look ahead search and the search is used in turn to improve the Q-values. The system learns from a combination of real experience and simulated, model-based experience.

### BACKGROUND

This specification relates to reinforcement learning.

In a reinforcement learning system, an agent interacts with an environment by performing actions that are selected by the reinforcement learning system in response to receiving observations that characterize the current state of the environment.

Some reinforcement learning systems select the action to be performed by the agent in response to receiving a given observation in accordance with an output of a neural network.

Neural networks are machine learning models that employ one or more layers of nonlinear units to predict an output for a received input. Some neural networks are deep neural networks that include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification generally describes a reinforcement learning system that selects actions to be performed by an agent interacting with an environment. The described system uses a combination of reinforcement learning, e.g. Q-learning, and look ahead search, to improve performance. The approach is particularly useful where a computational budget for the look ahead search is limited, and in complex environments.

In one aspect there is described a method of learning to select actions to be performed by an agent in an environment for performing a task. An action selection neural network is configured to receive data from an input observation characterizing a state of the environment and to process the input observation in accordance with action selection neural network parameters to generate an action selection output for defining a set of action selection scores (Q_{θ}) for selecting the actions to be performed by the agent. The action selection output may e.g. provide Q-values, i.e. state-action values, or may define a (multivariate) distribution from which Q-values may be sampled.

The method may comprise receiving an observation characterizing a current state of the environment. The method may further comprise performing a look ahead search from the current state of the environment over possible future states of the environment, e.g. starting with the current state. Performing the look ahead search may comprise, at each of a series of search steps determining an action by processing data characterizing a state of the environment at the search step using the action selection neural network to assist in selecting an action for the search step, e.g. by selecting an action with a maximum Q-value as refined by the search (Qₖ). Thus in implementations the action selection neural network provides a set of prior state action values for the search. The method may comprise processing the action for the search step using a model of the agent/environment, to determine data characterizing a state of the environment at a next search step. The model may be e.g. a simulator of the agent in the environment or a learned model which is able to generate data characterizing a next state of the environment from data characterizing a current state of the environment and a selected action.

The method may further comprise determining an updated action selection score or scores for the current state of the environment, e.g. an updated Q-value for a state-action pair (Q_{MCTS}), from a result of the look ahead search. The method may further comprise selecting an action to be performed by the agent using the updated action selection score(s) e.g. directly, using a Q-value or by sampling from a distribution updated using the updated score.

The method may further comprise receiving an observation characterizing a next state of the environment, and storing in a replay buffer transition data characterizing: the current state of the environment, the action, the next state of the environment, a reward received in response to the agent performing the action (there may be no reward), and the updated action selection score. This data may be stored for a plurality of different actions in a state.

The method may further comprise sampling the transition data stored in the replay buffer, and adjusting the action selection neural network parameters using gradients of an objective function determined from the sampled transition data e.g. by backpropagating the gradients. The objective function may comprise a first e.g. TD-learning or Q-learning term dependent on the reward received, and a second term dependent upon the updated action selection score(s). The second term may regress the action selection scores, e.g. Q-values, towards a Q-value distribution characterized by the updated action selection score(s).

In some implementations the method uses a combination of real experience and the results of a past look ahead search to improve a Q-function estimator i.e. the action selection neural network, which guides the next search. More particularly in implementations Q-learning provides a strong prior for the look ahead search, and the second term of the objective function amortizes a loss dependent upon the search results to improve the Q-function. This can provide an advantage over some other approaches which use state visit counts.

In some implementations performing the look ahead search comprises searching a state tree having nodes representing states of the environment e.g. from a root node representing the current state of the environment. The series of search steps may continue to a terminal node of the search. This is typically not a terminal state of the task or reinforcement learning episode, which may be defined by success or failure in the task.

The method may further comprise processing data characterizing the terminal search state of the environment to determine the action selection output for the terminal search state of the environment. The method may then determine a contribution to the result of the look ahead search from the action selection output for the terminal search state of the environment, e.g. by using the action selection output for the terminal search state of the environment as an estimate of a value of the terminal search state. For example the estimate of a value of the terminal search state may comprise a maximum action selection score (Q-value) or the value may be estimated by sampling from a distribution defined by the action selection output for the terminal search state of the environment.

Determining the result of the look ahead search may also include estimating a reward from the nodes of the search tree between the root node and the terminal node e.g. using the model and/or by predicting the reward(s) with a neural network; the reward may be discounted over the search steps. The (discounted) reward may be added to the an estimated value of the terminal state determined from the action selection output for the terminal search state of the environment as previously described. That is, determining the updated action selection score(s) may comprise summing a value derived from the result of the look ahead search and an action selection score from the action selection output for the current state of the environment. Thus an updated action selection score for a state-action pair may be determined from a combination of an action selection score for the state-action pair from the action selection neural network, an (estimated) value of a terminal state of the search, and the rewards or estimated rewards received by the agent between the state and the terminal state.

In implementations the action selection output of the action selection neural network comprises the set of action selection scores (e.g. Q-values). Using the action selection neural network to select an action for the search step may comprise selecting an action with a maximum action selection score for the search step. The action selection output for the terminal search state of the environment may comprises a maximum action selection score for the terminal search state of the environment.

In implementations the first term of the objective function comprises a temporal difference (TD) learning term dependent upon a difference between the output of the action selection neural network for the current state of the environment and a combination of the reward received and an estimated future reward from the next state of the environment from the action selection neural network. Here the current and next states refer to those in the transition data sampled from the replay buffer. The difference may be numerical or may be a difference between distributions. As previously described, the set of action selection scores may comprise Q-values for a discrete set of actions, and the action selection output may comprise a Q-value output. The TD learning term may implement e.g. TD(0), TD(1) or TD(λ) learning (bootstrapping towards a weighted estimated return n steps into the future).

In some implementations the action selection network output may define a predicted expected return, i.e. an estimate of a time-discounted return resulting from the environment being in the current state.

In general the method and a corresponding system may be applied to a range of different reinforcement learning techniques, including e.g. a Q-learning technique. Thus method/system may iteratively adjust values of the action selection neural network parameters using gradients of a reinforcement learning objective i.e. the first term of the objective function, with respect to the parameters, to increase a cumulative measure of reward received by the system. Merely by way of example, the techniques described herein may be used with DQN as described in Mnih et al (arXiv:1312.5602), R2D2 (Recurrent Replay Distributed DQN, Kapturowski et al.), and the graph-based approach of Bapst et al., 2019, as well as in principle techniques which learn from an action selection policy gradient such as an actor-critic reinforcement learning technique.

In implementations the second term of the objective function is dependent upon a difference, based on the transition data sampled from the replay buffer, between the action selection output for the current state of the environment and the updated action selection score(s) for the current state of the environment. In implementations the difference regresses a distribution of the action selection scores (Q-values) towards a distribution of the updated action selection score(s) (updated Q-values) derived from the look ahead searches. The difference may be determined e.g. by a cross-entropy loss between the distributions or by some other metric e.g. an L2 loss.

In implementations the look ahead search is similar to a Monte Carlo Tree Search (MCTS). In such cases a visitation count N(s, a) may be initialized to e.g. one for each state-action pair.

Once trained the action selection neural network may be used with or without a look ahead search to select actions for an agent performing a task.

Thus a method of performing a task by an agent in an environment comprises learning to select actions as previously described, to train the action selection neural network, and then using the trained action selection neural network to receive and process data from input observations characterizing states of the environment to generate action selection outputs, selecting the actions to be performed by the agent using the action selection outputs.

There is also provided an action selection neural network trained as described above.

In another aspect there is provided a neural network system for learning to select actions to be performed by an agent in an environment for performing a task. The system may comprise an action selection neural network is configured to receive data from an input observation characterizing a state of the environment and to process the input observation in accordance with action selection neural network parameters to generate an action selection output for defining a set of action selection scores for selecting the actions to be performed by the agent. The system may further comprise a replay buffer to store transition data. The system may further comprise a look ahead search subsystem or “engine”.

The look ahead search subsystem may be configured to receive an observation characterizing a current state of the environment, and perform a look ahead search from the current state of the environment over possible future states of the environment. Performing the look ahead search may comprise, at each of a series of search steps, determining an action by processing data characterizing a state of the environment at the search step using the action selection neural network to select (i.e. to assist in selecting) an action for the search step, and processing the action for the search step using a model to determine data characterizing a state of the environment at a next search step. The look ahead search subsystem may then determine an updated action selection score for the current state of the environment from a result of the look ahead search.

The neural network system may be configured to select an action to be performed by the agent using the updated action selection score; receive an observation characterizing a next state of the environment; store in the replay buffer transition data characterizing: the current state of the environment, the action, the next state of the environment, a reward received in response to the agent performing the action, and the updated action selection score; sample the transition data stored in the replay buffer; and adjust the action selection neural network parameters using gradients of an objective function determined from the sampled transition data, wherein the objective function comprises a first term dependent on the reward received and a second term dependent upon the updated action selection score.

In some implementations of the methods and systems described herein, the environment is a real-world environment, or a simulation of a real-world environment. The agent may comprise a mechanical agent interacting with the real-world environment, or a simulation of such a mechanical agent, or a control system for a mechanical agent, such as a robot of vehicle, interacting with the real-world environment.

For example, the agent may comprise a control system of an autonomous or semi-autonomous vehicle navigating through the environment. In these implementations, the actions may be possible control inputs to control the vehicle and the result that the agent is attempting to achieve is to satisfy objectives for the navigation of the vehicle through the real-world environment. For example, the objectives can include one or more of: reaching a destination, ensuring the safety of any occupants of the vehicle, minimizing energy used in reaching the destination, maximizing the comfort of the occupants. As another example, the agent may be a robot or other mechanical agent interacting with the environment to achieve a specific task, e.g., to locate an object of interest in the environment or to move an object of interest to a specified location in the environment.

In these implementations, the actions may be possible control inputs to control the robot. For example the actions may be control inputs to control the robot, e.g., torques for the joints of the robot or higher-level control commands; or to control the autonomous or semi-autonomous land or air or sea vehicle, e.g., torques to the control surface or other control elements of the vehicle or higher-level control commands; or e.g. motor control data. In other words, the actions can include for example, position, velocity, or force/torque/acceleration data for one or more joints of a robot or parts of another mechanical agent. Action data may include data for these actions and/or electronic control data such as motor control data, or more generally data for controlling one or more electronic devices within the environment the control of which has an effect on the observed state of the environment. For example in the case of an autonomous or semi-autonomous land or air or sea vehicle the actions may include actions to control navigation e.g. steering, and movement e.g. braking and/or acceleration of the vehicle.

In general the observations may include, for example, one or more of images, object position data, and sensor data to capture observations as the agent interacts with the environment, for example sensor data from an image, distance, or position sensor or from an actuator. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. For example in the case of a robot the observations may include data characterizing the current state of the robot, e.g., one or more of: joint position, joint velocity, joint force, torque or acceleration, and global or relative pose of a part of the robot such as an arm and/or of an item held by the robot. The observations may also include, for example, sensed electronic signals such as motor current or a temperature signal; and/or image or video data for example from a camera or a LIDAR sensor, e.g., data from sensors of the agent or data from sensors that are located separately from the agent in the environment.

The rewards, that is the external rewards from the environment, may include e.g. one or more rewards for approaching or achieving one or more target locations, one or more target poses, or one or more other target configurations. For example for a robot a reward may depend on a joint orientation (angle) or velocity, an end-effector position, a center-of-mass position, or the positions and/or orientations of groups of body parts. Costs (i.e. negative rewards) may be similarly defined e.g. dependent upon applied force when interacting with an object, energy usage, or positions of robot body parts.

The system/method may be used to train a vehicle or robot to perform a task such as warehouse, logistics, or factory automation task, e.g. collecting, placing, or moving stored goods or goods or parts of goods during their manufacture; or a learned task may comprise a package delivery control task. The actions may include actions relating to steering or other direction control actions, and the observations may include observations of the positions or motions of other vehicles or robots. A robot or vehicle may be trained in simulation before being used in a real-world environment, with or without the look ahead search subsystem.

Thus in some applications the agent may be an electronic agent and the observations may include data from one or more sensors monitoring part of a plant or service facility such as current, voltage, power, temperature and other sensors and/or electronic signals representing the functioning of electronic and/or mechanical items of equipment. The agent may control actions in a real-world environment including items of equipment, for example in a facility such as: a data center, server farm, or grid mains power or water distribution system, or actions in a manufacturing plant or service facility, or actions in an electrical power generation facility such as a solar or wind farm. The observations may then relate to operation of the plant or facility, e.g. they may include observations of power or water usage by equipment, or observations of power generation or distribution control, or observations of usage of a resource or of waste production. The actions may include actions controlling or imposing operating conditions on items of equipment of the plant/facility, and/or actions that result in changes to settings in the operation of the plant/facility e.g. to adjust or turn on/off components of the plant/facility. A learned task may be a control task, with corresponding rewards, e.g. resource usage e.g. water or power control; environmental impact control, electrical or other power consumption control; heating, cooling or temperature control, and generally control of items within the facility. A reward may comprise one or more rewards dependent on performance of such a control task.

In some other implementations the real-world environment may be a manufacturing plant or service facility, the observations may relate to operation of the plant or facility, for example to resource usage such as power consumption, and the agent may control actions or operations in the plant/facility, for example to reduce resource usage.

In some other implementations the real-world environment may be a renewal energy plant, the observations may relate to operation of the plant, for example to maximize present or future planned electrical power generation, and the agent may control actions or operations in the plant to achieve this.

Thus in general terms, in implementations the agent may be a mechanical or electronic agent and the actions may comprise control inputs to control the mechanical or electronic agent. The observations may be derived from sensors, for example image sensors, and/or they may be derived from electrical or mechanical signals from the agent.

In some further implementations, the environment is a real-world environment and the agent is a computer system that generates outputs for presentation to a user. For example, the environment may be a patient diagnosis environment such that each state is a respective patient state of a patient, i.e., as reflected by health data characterizing the health of the patient, and the agent may be a computer system for suggesting treatment for the patient. In this example, the actions in the set of actions are possible medical treatments for the patient and the result to be achieved can include one or more of maintaining a current health of the patient, improving the current health of the patient, minimizing medical expenses for the patient, and so on. The observations may comprise data from one or more sensors, such as image sensors or biomarker sensors, and/or may comprise processed text, for example from a medical record.

As another example, the environment may be a chemical synthesis or protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that performs or controls the protein folding actions or chemical synthesis steps selected by the system automatically without human interaction. The observations may comprise direct or indirect observations of a state of the protein or chemical/intermediates/precursors and/or may be derived from simulation.

In some applications the agent may be a static or mobile software agent i.e. a computer programs configured to operate autonomously and/or with other software agents or people to perform a task. For example the environment may be an integrated circuit routing environment and the system may be configured to learn to perform a routing task for routing interconnection lines of an integrated circuit such as an ASIC. The rewards (or costs) may then be dependent on one or more routing metrics such as an interconnect resistance, capacitance, impedance, loss, speed or propagation delay, physical line parameters such as width, thickness or geometry, and design rules. The observations may be observations of component positions and interconnections; the actions may comprise component placing actions e.g. to define a component position or orientation and/or interconnect routing actions e.g. interconnect selection and/or placement actions. The routing task may thus comprise placing components i.e. determining positions and/or orientations of components of the integrated circuit, and/or determining a routing of interconnections between the components. Once the routing task has been completed an integrated circuit, e.g. ASIC, may be fabricated according to the determined placement and/or routing.

In some applications the environment may be a data packet communications network environment, and the agent may comprise a router to route packets of data over the communications network. The actions may comprise data packet routing actions and the observations may comprise e.g. observations of a routing table which includes routing metrics such as a metric of routing path length, bandwidth, load, hop count, path cost, delay, maximum transmission unit (MTU), and reliability. A learned task may include be packet routing task with rewards/costs to maximize or minimize one or more of the routing metrics. In some other applications the agent is a software agent which manages distribution of compute tasks across computing resources e.g. on a mobile device and/or in a data center. In these implementations, the observations may include observations of computing resources such as compute and/or memory capacity, or Internet-accessible resources; and the actions and a related task may include assigning compute tasks to particular computing resources. The rewards may be dependent upon e.g. utilization of computing resources, electrical power, bandwidth, and computation speed.

In some other applications the environment is an Internet or mobile communications environment and the agent is a software agent which manages a personalized recommendation for a user. The observations may comprise (features characterizing) previous actions taken by the user; a task may include actions recommending items such as content items to a user. The rewards may include an estimated likelihood that the user will respond favorably to being recommended the (content) item, or a number of recommendations received by the user (optionally within a time span); a cost may be dependent on the suitability of one or more recommended items, a cost of the recommended item(s). As further example, the actions may include presenting advertisements, the observations may include advertisement impressions or a click-through count or rate, and the reward may characterize previous selections of items or content taken by one or more users.

In some further applications, the environment is a cybersecurity environment. For example, the observations may comprise data characterizing a state of a computer network or a distributed computing system, and the actions may define one or more tasks to be performed to defend the computer system against a cybersecurity attack e.g. by one or more other agents. A reward may comprise one or more rewards dependent on a measure of system/environment security e.g. on a number of detected attacks.

In some other implementations, the environment is a simulated environment and the agent is implemented as one or more computer programs interacting with the simulated environment. For example, the simulated environment may be a virtual environment in which a user competes against a computerized agent to accomplish a goal and the agent is the computerized agent. In this example, the actions in the set of actions are possible actions that can be performed by the computerized agent and the result to be achieved may be, e.g., to win the competition against the user.

In some implementations, the environment is a simulated environment and the agent is implemented as one or more computer programs interacting with the simulated environment. For example, the simulated environment may be a video game and the agent may be a simulated user playing the video game. As another example, the simulated environment may be a motion simulation environment, e.g., a driving simulation or a flight simulation, and the agent is a simulated vehicle navigating through the motion simulation. In these implementations, the actions may be control inputs to control the simulated user or simulated vehicle.

In general in the above described applications, where the environment is a simulated version of a real-world environment, once the system/method has been trained in the simulation it may afterwards be applied to the real-world environment. That is control signals generated by the system/method may be used to control the agent to perform a task in the real-world environment in response to observations from the real-world environment. Optionally the system/method may continue training in the real-world environment based on one or more rewards from the real-world environment.

The subject matter described in this specification can be implemented in particular embodiments so as to realize one or more of the following advantages.

As previously described examples of the method uses a combination of “real” experience i.e. experience from the environment as opposed to experience from the model/simulation, and the results of look ahead searches using the model/simulation, to improve a value function i.e. a Q-function estimator implemented by the action selection neural network. The Q-function provides a strong prior for the search and can help the search to avoid suboptimal actions, facilitating rapid improvement of the Q-function via the amortization loss, i.e. the second term of the objective function. More specifically, in implementations a Q-function is used for the look ahead search, in particular for node selection and for estimating a value for a new node, and then the method/system regresses the Q-function to an updated distribution based on a combination of the search and temporal difference learning.

Such an approach can provide an improvement over one which regresses towards state-action visit counts, especially where there is a limited search budget i.e. a limited number of tree searches which may be performed. One reason for this is because, conventionally, with a small search budget the search tree may be insufficiently explored and an action with by chance a high visit count may be sub-optimal but nevertheless reinforced. This is because the high visit count of such an action biases the process so that the action, although poor, is more likely to be explored in the future.

Another problem that can arise when learning using planned actions is that the planning process generally avoids suboptimal actions. Thus a reinforcement learning process combined with a planning process may rarely or never recommend some poor actions, and a learned Q-function may not learn to downweight such actions. Some implementations of the techniques described herein avoid this by using poor actions experienced during the search to guide the Q-improvement process, that is by using information obtained during the search process, i.e. state-action values estimated during the search. This information is ultimately propagated back into the Q-function (via the updated action selection scores from the search) to help fit the Q-function, that is to improve the Q-values from the action selection neural network.

Implementations of the described system can thus help to improve the search-based planning performance, especially if the total number of states explored is relatively small. This in turn can help to reduce computational costs and memory requirements. It can also facilitate using more complex models, and/or modelling more complex tasks, and achieving good performance where there are many states of the environment to evaluate. This can also help the system to achieve better performance in complex, real-world tasks e.g. by learning faster than other systems or by learning to perform tasks on which other systems may fail.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF DRAWINGS

FIG. 1 shows a reinforcement learning system that implements a look ahead search.

FIGS. 2a and 2b are flow diagrams of an example process for training the reinforcement learning system of FIG. 1.

FIGS. 3a and 3b illustrate schematically the operation of an example of the reinforcement learning system of FIG. 1.

In the Figures like reference numerals indicate like elements.

### DETAILED DESCRIPTION

This specification describes a neural network based reinforcement learning system and method. The system combined model-free reinforcement learning with model-based planning to improve training. The model-based planning uses a look ahead search, such as a Monte Carlo Tree Search (MCTS), to improve the performance of the model-free learning. The look ahead search may employ a learned model or a simulation an environment in which the system operates.

In implementations an action selection neural network defines values, such as state-action values or Q-values, which are used to guide the look ahead search, and results from the search are in turn used to improve an output of the action selection neural network defining the values. Thus the action selection neural network learns from a combination of a value-based objective function, and an “amortized” objective function which encourages the output of the action selection neural network towards values derived from the look ahead search. The system therefore learns from a combination of real experience and simulated, i.e. model-based experience.

The approach can be used with any reinforcement learning system with access to a model, and by contrast to typical model-based approaches, is able to learn rapidly with a very small search budget. For example whereas some systems can require thousands of MCTS model evaluations per action during training, some implementations of the system described herein can use one or two orders of magnitude fewer evaluations. This is particularly useful where the simulation is computationally expensive, for example because it is complex or because the action space is large.

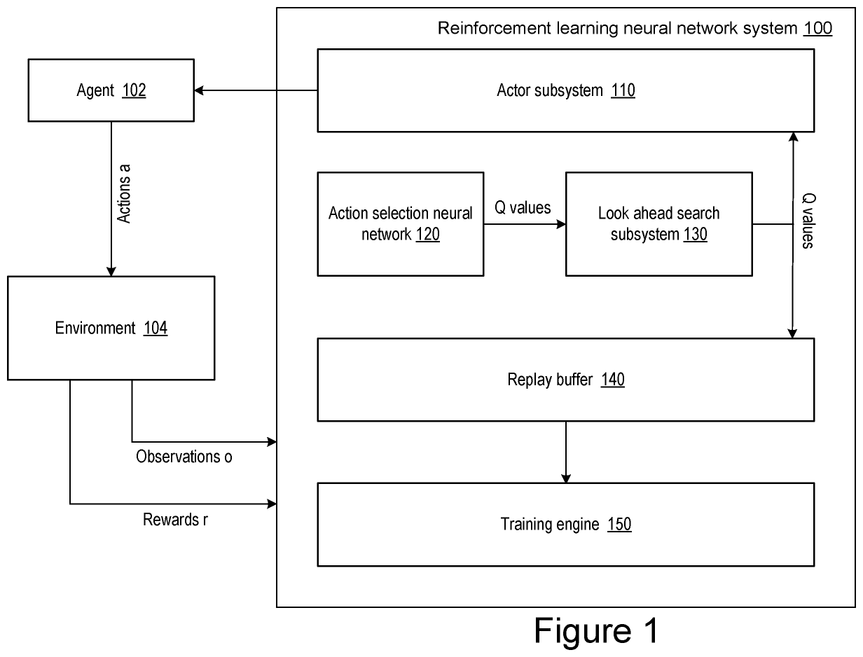

FIG. 1 shows a reinforcement learning system 100 that may be implemented as computer programs on one or more computers in one or more locations. The reinforcement learning system 100, at each of multiple time steps, t, selects an action, a, to be performed by an agent 102 in an environment 104. At each time step the reinforcement learning system 100 receives and processes data characterizing a state, s, of the environment, referred to herein as an observation, o, for selecting an action.

Thus in this specification references to a state, s, of the environment are used as shorthand for references to an observation, o, characterizing the state, s, of the environment. The observation may include an image of the environment and/or other sensor or input data from the environment. Such observations are typically pre-processed e.g. by one or more convolutional neural network layers, and/or by one or more recurrent neural network layers for example where the environment is only partially observed (not shown in FIG. 1).

The reinforcement learning system 100 may also receive a reward r as a result of performing the action a. In general the reward is a numerical value and may be based on any event or aspect of the environment. For example, the reward r may indicate whether the agent 106 has accomplished a task (e.g., a manipulation task, or navigating to a target location in the environment) or progress of the agent 106 towards accomplishing a task.

In some implementations, the environment is a real-world environment or a simulation of a real-world environment. The agent may comprise a mechanical agent, such as a robot or vehicle, or a simulation of a mechanical agent, or a control system for a mechanical agent. Alternatively, for example, the agent may comprise a software agent to perform a control or routing task in a communications network or computer system, or for an integrated circuit. Other applications of the reinforcement learning system 100 have been described previously.

Referring again to FIG. 1, the reinforcement learning system 100 includes an action selection neural network 120. The action selection neural network 120 receives and processes an observation o of a state s and generates an action selection output for defining a set of action selection scores which are used for selecting actions to be performed by the agent. For example the action selection output may determine the action selection scores, or may parameterize a set of distributions representing the action selection scores from which action selection scores may be selected stochastically.

The reinforcement learning system 100 also includes a look ahead search subsystem 130. As described later, the action selection scores are used as a prior for a look ahead search performed by the look ahead search subsystem 130. In some implementations the action selection neural network 120 is a Q-value neural network with parameters θ, Q_{θ}, that receives an action, a, and generates an action-value score Q_{θ}(s, a).

The look ahead search subsystem 130 generates an updated set of action selection scores by performing the look ahead search, from a current state of the environment over possible future states of the environment, using the set of action selection scores from the action selection neural network 120. In some implementations look ahead search subsystem 130 performs a Monte Carlo Tree Search (MCTS) and the updated set of action selection scores comprises an improved Q-value, Q_{MCTS}(s, a), for each action a of a set of possible actions.

More particularly, at each of a series of search steps the look ahead search subsystem 130 determines an action by processing data characterizing a state of the environment at the search step, i.e. data from an observation o, using the action selection neural network, to thereby progress down a search tree. The action is determined by a search policy, which depends on the action selection scores from the action selection neural network. The action for the search step is processed using a model (simulation) to determine data characterizing a state of the environment at a next search step. Each iteration of the look ahead search is used to progressively refine the action selection scores, and after a number of iterations an updated (improved) set of action selection scores is returned, e.g. Q_{MCTS}(s, a) for each possible action a in state s, later denoted Q_{MCTS}(s,⋅).

An actor subsystem 110 uses the updated set of action selection scores to select an action. For example the actor subsystem 110 may select an action with a highest action selection score or, for example, the action selection scores may be processed using a soft-max function to generate respective probability values which can be used to select the action. Optionally the actor subsystem 110 may also implement an exploration policy such as an epsilon-greedy exploration policy, effectively adding exploration noise to the action selections e.g. by choosing an action (from those explored during the search) uniformly at random with a probability E. As previously described, in response the reinforcement learning system 100 receives an observation characterizing a next state of the environment, and optionally a reward.

For each step of real experience i.e. as contrasted with the look ahead search, a replay buffer 140 stores transition data comprising the current state of the environment, the action, the next state of the environment, a reward received in response to the agent performing the action, and the updated action selection scores.

A training engine 150 is configured to train the reinforcement learning system 100 using samples of the stored transition data. Thus the training engine 150 is configured to adjust the parameters of the action selection neural network by backpropagating using gradients of an objective function determined from the sampled transition data. The objective function comprises a first term which may be any value-based objective function i.e. a term dependent on the reward received, and a second term comprising an “amortized” objective function i.e. a term dependent upon the updated action selection score. The first and second terms of the objective function may be weighted to match their relative scales.

In broad terms the training engine 150 adjusts the parameters of the action selection neural network based on both real experience and the look ahead search, and the action selection output of the action selection neural network is then used in turn to guide the look ahead search. The better-guided look ahead search then further improves the action selection output. In this way implementations of the system and method are able to learn faster i.e. from less experience and/or with a smaller simulation search budget, than might otherwise be the case, and can provide improved final performance.

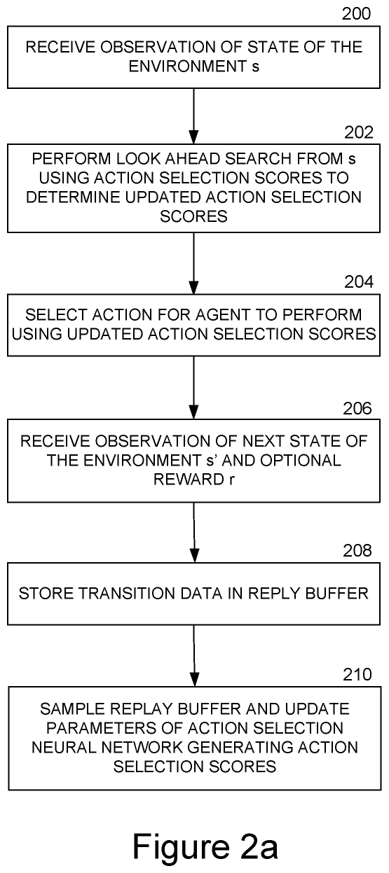

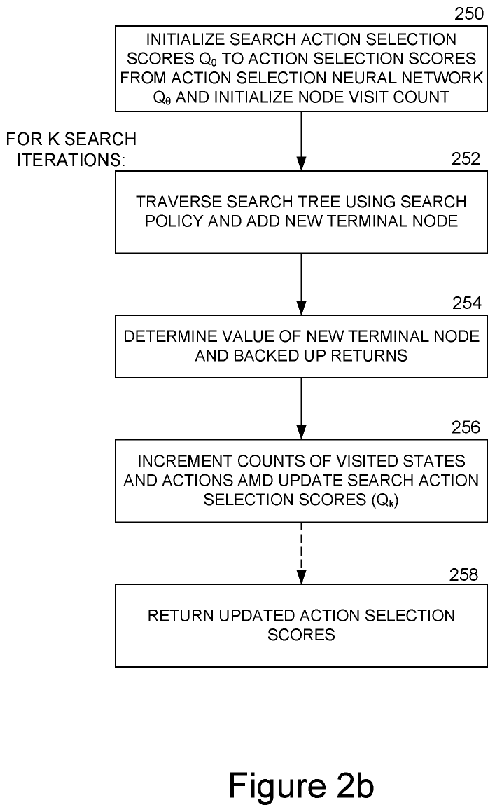

FIGS. 2a and 2b are flow diagrams of an example process for training the reinforcement learning system 100. The process of FIG. 2 shows one time step; the process is repeated to control the agent to act at successive time steps.

Referring to FIG. 2a, the process receives an observation of a state s of the environment (step 200), and performs a look ahead search from state s using action selection scores from the action selection neural network 120 to determine a set of updated action selection scores (step 202). Details of the look ahead search are described with reference to FIG. 2b.

The updated action selection scores are used to select an action a for the agent to perform in the environment (step 204), and an observation of a next state of the environment s′ is received with an optional reward r (step 206). Transition data comprising data e.g. characterizing the experience tuple (s, a, r, s′, Q_{MCTS}(s,⋅)) is stored in the replay buffer 140 (step 208). Whilst the reinforcement learning system 100 is learning one or more e.g. a minibatch of experience tuples is sampled from the replay buffer 140 and used to update the parameters of the action selection neural network 110 (step 210). After training steps 208 and 210 may be omitted.

FIG. 2b shows details of an example process for performing the look ahead search. The search is performed over a search tree in which nodes represent states of the environment and edges represent actions performed by the agent. The search involves K iterations, that is the search tree is traversed K times from a root node defined by an initial state of the environment s when the search was initiated.

At the start of the search action selection values e.g. Q-values are initialized for states and actions in the tree (step 250). This may comprise setting an initial Q-value, Q₀(s, a), for each state and action in the search tree. In implementations Q₀ (s, a)=Q_{θ}(s, a), that is the initial Q-value is defined by the set of action selection scores from the action selection neural network for each state s and possible action a from that state. A state-action visit count N₀ (s, a) may also be initialized e.g. to 1 for each state and action in the search tree (step 250). This would be the situation if each state-action pair had been visited once with each estimated state-action value given by Q_{θ}(s, a). In some other implementations the state-action visit count may be initialized to an estimate of previous visit counts.

A process as defined in steps 252-256, e.g. an MCTS-type process, is then performed for each of the iterations, starting with k=0.

Starting from the root node, state s, the look ahead search traverses the search tree by performing a succession of search steps, each identifying an action according to the search policy, until a new, terminal search state s_{T} is added to the search tree (step 252). The new, terminal search state s_{T} is typically not, though can be, a terminal state of a task performed by the reinforcement learning system. In some implementations the search policy for iteration k, πₖ(s), is given by

$${π}_{k} ( s ) = {argmax}_{a} ( {Q}_{k} ( s , a ) + {U}_{k} ( s , a ) )$$

where Uₖ (s, a) is an exploration term which may represent an upper confidence bound for the tree (UCT). In implementations

$${U}_{k} ( s , a ) = {c}_{UCT} \sqrt{\frac{{\sum }_{a} {N}_{k} ( s , a )}{{N}_{k} ( s , a )}}$$

where the sum over actions ΣₐNₖ(s, a) represents a total number simulations (backed up returns) for state s following initialization, Nₖ(s, a) represents a number simulations in which action a was taken from state s, and C_{UCT} is a constant that encourages exploration e.g. \sqrt{2}. For k>0 a value for Qₖ(s, a) may be determined as described later.

As the search tree is traversed an action is selected according to the search policy, and the next state of the environment is determined using the model (simulation), until a new action, a_{T-1} that has not previously been explored is selected from state s_{T-1}, resulting in a reward t_{T-1} and new, terminal search state s_{T}. The new, terminal search state s_{T} is added to the search tree and a value of this state is determined as a result of the look ahead search (step 254). More specifically the value of this state, V(s_{T}), may be determined from the action selection output of the action selection neural network for the terminal search state of the environment. For example where the value of state s_{T} is provided deterministically it may be determined as a maximum action selection score of the state,

$$V ( {s}_{T} ) = {max}_{a} {Q}_{θ} ( {s}_{T} , a )$$

A “backed up” return value, may then be determined for each state-action pair (sₜ, aₜ) traversed by the search. The return value may be determined from the value of state s_{T} and from the (time-discounted) estimated rewards from the nodes of the search tree traversed between the root node and the terminal node. For example a return Rᵢ(sₜ, aₜ) for an ith simulated traverse since initialization may be estimated as

$${R}_{i} ( {s}_{t} , {a}_{t} ) = {γ}^{T - t} V ( {s}_{T} ) + {\sum }_{j = t}^{T - 1} {γ}^{j - t} {r}_{j}$$

The process may then increment counts of visited states and actions, Nₖ(S, a), and update the search action selection scores, e.g. the values of Qₖ(s, a), for the visited states and actions (step 256). For example, k>0 a value for Qₖ(s, a) may be determined according to

$${Q}_{k} ( s , a ) = \frac{{Q}_{θ} ( s , a ) + {\sum }_{i = 1}^{{N}_{k} ( s , a ) - 1} {R}_{i} ( s , a )}{{N}_{k} ( s , a )}$$

where the sum suns over visited states and actions.

After K iterations the updated search action selection scores, e.g. the value of Q_{K}(s, a), may be returned as the updated action selection score, e.g. Q_{MCTS}(s, a), used by the process of FIG. 2a (step 258).

Referring again to FIG. 2a, in some implementations an objective function, [symbol] , used to update the parameters of the action selection neural network 110 (step 210) may be given by

[symbol]

=β_{Q} [symbol] _{Q}+β_{A} [symbol] _{A}

where [symbol] _{Q} is any reinforcement learning value-based loss function, e.g. based on a 1-step or n-step TD (Temporal Difference) target or based on a λ-return, [symbol] _{A} is an “amortized” objective function, and β_{Q} and β_{A} are respective weights. Each of [symbol] _{Q} and [symbol] _{A} may be determined from data for a batch, [symbol] , of N experience tuples sampled from the replay buffer 140.

For example [symbol] _{Q} may depend on a difference between the output of the action selection neural network for the current state of the environment and an estimate of a return that will be received by the system if the agent performs a given action in response to the observation, e.g. a combination of the reward received and an estimated (time-discounted) future reward, i.e. return, from the next state of the environment from the action selection neural network.

The “amortized” objective [symbol] _{A} may depend on a difference between the action selection output for the current state of the environment and the updated action selection scores for the current state of the environment. The difference may comprise a squared loss e.g. an L2 norm, or a cross-entropy loss. Using a cross-entropy loss can improve performance, i.e. can help the action selection output to learn good action selection scores faster. A cross-entropy loss compares relative action selection score values rather than absolute values, i.e. it compares score distributions. This allows the updated action selection scores from the search to be used without relying on these too strongly, which can be helpful when search budgets are small; it can also avoid over-reliance on low-value actions which tend to be avoided by the search.

In one implementation the action selection scores from the action selection neural network, Q_{θ}(s,⋅), and the updated action selection scores from the look ahead search, Q_{MCTS}(s,⋅), are each converted to a respective probability distribution by applying a softmax function, p_{MCTS}=softmax(Q_{MCTS} (s,⋅),) and p_{θ}=softmax(Q_{θ}(s,⋅),). Then a cross-entropy loss may be determined as

$${ℒ}_{A} = - \frac{1}{N} {\sum }_{𝒟} {( {p}_{MCTS} )}^{T} log {p}_{θ}$$

where T is an optional temperature parameter which controls the softmax temperature.

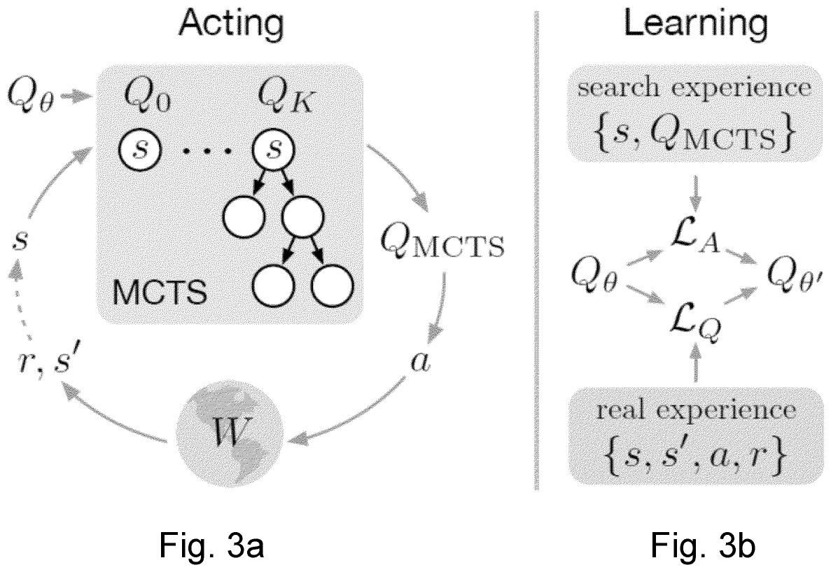

FIGS. 3a and 3b summarize the operation of an example reinforcement learning system 100 as described above. Thus in broad terms, the action selection scores from the action selection neural network, Q_{θ}(s,⋅), act as a prior for the updated Q-values, Qₖ, estimated during a Monte Carlo Tree Search. Over K steps of the search an initial set of Q-values, Q₀(s,⋅)=Q_{θ}(s,⋅), is improved to Q_{K}, which is returned as an updated set of action selection scores, Q_{MCTS}(s,). This updated set of action selection scores is then used to select an action a, e.g. with an epsilon-greedy exploration policy, and the resulting experience (s, a, r, s′, Q_{MCTS}(s,⋅)) is added to the replay buffer. When learning the system uses real experience (rewards) to update Q_{θ}(s,⋅) by Q-learning, and uses an amortization loss to regress Q_{θ}(s,⋅) towards the updated set of action selection scores estimated by the search.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them. The computer storage medium is not, however, a propagated signal.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows can be performed by and apparatus can also be implemented as a graphics processing unit (GPU).

Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

1. A computer implemented method of learning to select actions to be performed by an agent in an environment for performing a task,
wherein an action selection neural network is configured to receive data from an input observation characterizing a state of the environment and to process the input observation in accordance with action selection neural network parameters to generate an action selection output for defining a set of action selection scores for selecting the actions to be performed by the agent,
wherein the method comprises:
receiving an observation characterizing a current state of the environment;
performing a look ahead search from the current state of the environment over possible future states of the environment,
wherein performing the look ahead search comprises, at each of a series of search steps, determining an action by processing data characterizing a state of the environment at the search step using the action selection neural network to select an action for the search step, and processing the action for the search step using a model to determine data characterizing a state of the environment at a next search step;
determining an updated action selection score for the current state of the environment from a result of the look ahead search;
selecting an action to be performed by the agent using the updated action selection score;
receiving an observation characterizing a next state of the environment;
storing in a replay buffer transition data characterizing: the current state of the environment, the action, the next state of the environment, a reward received in response to the agent performing the action, and the updated action selection score;
sampling the transition data stored in the replay buffer; and
adjusting the action selection neural network parameters using gradients of an objective function determined from the sampled transition data, wherein the objective function comprises a first term dependent on the reward received and a second term dependent upon the updated action selection score.

2. The method of claim 1 wherein performing the look ahead search comprises searching a state tree having nodes representing states of the environment from a root node representing the current state of the environment, wherein the series of search steps continues to a terminal node of the search, the method further comprising processing data characterizing the terminal search state of the environment to determine the action selection output for the terminal search state of the environment, and determining the result of the look ahead search from the action selection output for the terminal search state of the environment.

3. The method of claim 2 wherein determining the result of the look ahead search further comprises estimating a reward from the nodes of the search tree between the root node and the terminal node, and adding the estimated reward to the an estimated value of the terminal state determined from the action selection output for the terminal search state of the environment.

4. The method of claim 2 wherein determining the updated action selection score comprises summing a value derived from the result of the look ahead search and an action selection score from the action selection output for the current state of the environment.

5. The method of claim 2 wherein the action selection output of the action selection neural network comprises the set of action selection scores, and wherein using the action selection neural network to select an action for the search step comprises selecting an action with a maximum action selection score for the search step.

6. The method of claim 5 wherein the action selection output for the terminal search state of the environment comprises a maximum action selection score for the terminal search state of the environment.

7. The method of claim 1 wherein the first term of the objective function comprises a temporal difference learning term dependent upon a difference, based on the transition data sampled from the replay buffer, between the output of the action selection neural network for the current state of the environment and a combination of the reward received and an estimated future return from the next state of the environment from the action selection neural network.

8. The method of any claim 1 wherein the second term of the objective function is dependent upon a difference, based on the transition data sampled from the replay buffer, between the action selection output for the current state of the environment and the updated action selection score for the current state of the environment.

9. The method of any claim 1 wherein the second term of the objective function comprises a cross-entropy loss between a set of action selection scores for the current state of the environment from the action selection neural network and a corresponding set of updated action selection scores for the current state of the environment from the look ahead search.

10. The method of claim 1 wherein the set of action selection scores comprise Q-values for a discrete set of actions, and wherein the action selection output comprises a Q-value output.

11. The method of claim 10 wherein using the action selection neural network to select an action for the search step comprises selecting an action with a highest Q-value, subject to exploration noise.

12. (canceled)

13. (canceled)

14. (canceled)

15. A neural network system for learning to select actions to be performed by an agent in an environment for performing a task, the system comprising:
an action selection neural network is configured to receive data from an input observation characterizing a state of the environment and to process the input observation in accordance with action selection neural network parameters to generate an action selection output for defining a set of action selection scores for selecting the actions to be performed by the agent,
a replay buffer to store transition data; and
a look ahead search subsystem;
wherein the look ahead search subsystem is configured to:
receive an observation characterizing a current state of the environment;
perform a look ahead search from the current state of the environment over possible future states of the environment,
wherein performing the look ahead search comprises, at each of a series of search steps, determining an action by processing data characterizing a state of the environment at the search step using the action selection neural network to select an action for the search step, and processing the action for the search step using a model to determine data characterizing a state of the environment at a next search step;
determine an updated action selection score for the current state of the environment from a result of the look ahead search; and
wherein the neural network system is configured to:
select an action to be performed by the agent using the updated action selection score;
receive an observation characterizing a next state of the environment;
store in the replay buffer transition data characterizing: the current state of the environment, the action, the next state of the environment, a reward received in response to the agent performing the action, and the updated action selection score;
sample the transition data stored in the replay buffer; and
adjust the action selection neural network parameters using gradients of an objective function determined from the sampled transition data, wherein the objective function comprises a first term dependent on the reward received and a second term dependent upon the updated action selection score.

16. (canceled)

17. The system of claim 15 wherein performing the look ahead search comprises searching a state tree having nodes representing states of the environment from a root node representing the current state of the environment, wherein the series of search steps continues to a terminal node of the search, the method further comprising processing data characterizing the terminal search state of the environment to determine the action selection output for the terminal search state of the environment, and determining the result of the look ahead search from the action selection output for the terminal search state of the environment.

18. The system of claim 17 wherein determining the result of the look ahead search further comprises estimating a reward from the nodes of the search tree between the root node and the terminal node, and adding the estimated reward to the an estimated value of the terminal state determined from the action selection output for the terminal search state of the environment.

19. The system of claim 17 wherein determining the updated action selection score comprises summing a value derived from the result of the look ahead search and an action selection score from the action selection output for the current state of the environment.

20. The system of claim 17 wherein the action selection output of the action selection neural network comprises the set of action selection scores, and wherein using the action selection neural network to select an action for the search step comprises selecting an action with a maximum action selection score for the search step.

21. The system of claim 17, wherein the action selection output for the terminal search state of the environment comprises a maximum action selection score for the terminal search state of the environment.

22. The system of claim 15 wherein the first term of the objective function comprises a temporal difference learning term dependent upon a difference, based on the transition data sampled from the replay buffer, between the output of the action selection neural network for the current state of the environment and a combination of the reward received and an estimated future return from the next state of the environment from the action selection neural network.

23. The system of any claim 15 wherein the second term of the objective function is dependent upon a difference, based on the transition data sampled from the replay buffer, between the action selection output for the current state of the environment and the updated action selection score for the current state of the environment.

24. One or more non-transitory computer-readable storage media storing instructions that when executed by one or more computers are operable to cause the one or more computers to perform operations for learning to select actions to be performed by an agent in an environment for performing a task,
wherein an action selection neural network is configured to receive data from an input observation characterizing a state of the environment and to process the input observation in accordance with action selection neural network parameters to generate an action selection output for defining a set of action selection scores for selecting the actions to be performed by the agent,
wherein the operations comprise:
receiving an observation characterizing a current state of the environment;
performing a look ahead search from the current state of the environment over possible future states of the environment,
wherein performing the look ahead search comprises, at each of a series of search steps, determining an action by processing data characterizing a state of the environment at the search step using the action selection neural network to select an action for the search step, and processing the action for the search step using a model to determine data characterizing a state of the environment at a next search step;
determining an updated action selection score for the current state of the environment from a result of the look ahead search;
selecting an action to be performed by the agent using the updated action selection score;
receiving an observation characterizing a next state of the environment;
storing in a replay buffer transition data characterizing: the current state of the environment, the action, the next state of the environment, a reward received in response to the agent performing the action, and the updated action selection score;
sampling the transition data stored in the replay buffer; and
adjusting the action selection neural network parameters using gradients of an objective function determined from the sampled transition data, wherein the objective function comprises a first term dependent on the reward received and a second term dependent upon the updated action selection score.
